(19) United States
(12) Patent Application Publication
(10) Pub. No.: US 2007/0250697 A1
(43) Pub. Date: Oct. 25, 2007

(54) Remote monitoring method for computer system

(75) Inventors: Chien-Chen Lai, Taipei (TW); Kai-Feng Chiu, Taipei (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/647,319

(22) Filed: Dec. 29, 2006

(30) Foreign Application Priority Data
Apr. 20, 2006 (TW) 095114147

(51) Int. Cl. G06F 9/00

(52) U.S. Cl. 713/2; 709/223

(57) ABSTRACT

A remote monitoring method applied in a monitored computer system and a monitoring computer system, which are connected to a network. The monitored computer system has a microprocessor chip which operates independently. After power is supplied to the monitored computer system, the microprocessor chip starts to capture image data. The image data is properly processed and then stored in the memory. Thereafter, the monitoring computer system reads and displays the image data stored in the memory through the network so that the user can see, on the monitoring computer system, displaying images of the monitored computer system from booting to normal operating, and also can capture a displaying image when the monitored computer system crashes.

This application claims the benefit of Taiwan application Serial No. 95114147, filed Apr. 20, 2006, the subject matter of which is incorporated herein by reference.

### BACKGROUND OF THE INVENTION

1. Field of the Invention

The invention relates in general to a remote monitoring method, and more particularly to a remote monitoring method applied in a monitored computer system and a monitoring computer system which are connected to a network.

2. Description of the Related Art

In a conventional remote monitoring method for a computer, monitoring software is installed in an operation system (e.g., Windows operation system) to capture and transmit a displaying image of a monitored computer system to a monitoring computer system.

As mentioned hereinabove, it is necessary to develop different monitoring software corresponding to different operation systems. Consequently, the cost of setting the remote monitor system is increased. In addition, the monitored and monitoring computer systems cannot have the function of the remote monitor system until they enter the Window operation system. Thus, all the procedures from booting to normal operating cannot be monitored, and the displaying image of crash also cannot be monitored. This is because the monitoring software cannot operate if the operation system cannot operate.

Due to the various limitations described hereinabove, it is an important subject in this field to provide a remote monitoring method without the above-mentioned drawbacks.

### SUMMARY OF THE INVENTION

It is therefore an object of the invention to provide a remote monitoring method of enabling a user to monitor displaying frames from booting to normal operating or the displaying frame of crash using a typical network browser.

The invention achieves the above-identified object by providing a remote monitoring method applied in a monitored computer system and a monitoring computer system which are connected to a network. The monitored computer system has a signal capturing unit and a memory. The method includes the steps of: enabling the signal capturing unit to start to capture image data after power is supplied to the monitored computer system; enabling the signal capturing unit to compress the image data into compressed image data and store the compressed image data to the memory; and enabling the monitoring computer system to read the compressed image data through the network and to display the compressed image data as an image frame.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a remote monitor system;

FIG. 2 is a schematic illustration showing a monitored computer system according to a preferred embodiment of the invention; and

FIG. 3 is a flow chart showing a remote monitoring method according to the preferred embodiment of the invention.

### DETAILED DESCRIPTION OF THE INVENTION

The invention discloses a remote monitoring method applied in a monitored computer system and a monitoring computer system which are connected to a network. The monitored computer system has a microprocessor chip which operates independently. After power is supplied to the monitored computer system, the microprocessor chip starts to capture image data, which is processed properly and then stored in a memory. Thereafter, the monitoring computer system reads and displays the image data stored in the memory through the network so as to enable a user to see, on the monitoring computer system, displaying images of the monitored computer system from booting to normal operating. It is also possible to capture the displaying image when the monitored computer system crashes.

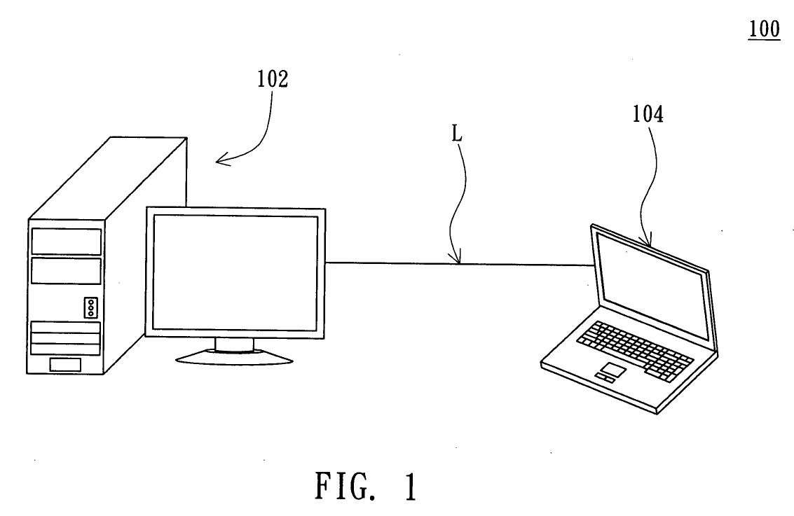

FIG. 1 is a schematic illustration showing a remote monitor system 100. Referring to FIG. 1, the remote monitor system 100 includes a network L, a monitored computer system 102 and at least one monitoring computer system 104. Each of the monitored computer system 102 and the monitoring computer system 104 may be, for example, a notebook computer, a barebone system, a desktop computer or a server. In this embodiment, the type of the computer system is not particularly limited. In FIG. 1, the monitored computer system 102 is a server, and the monitoring computer system 104 is a notebook computer. The network L may be, for example, the local area network, the wide area network, the wireless network or the Internet network. In this embodiment, the type of the network L is not particularly limited as long as the monitored computer system 102 and the monitoring computer system 104 can be interconnected through the network L to perform the signal transmission.

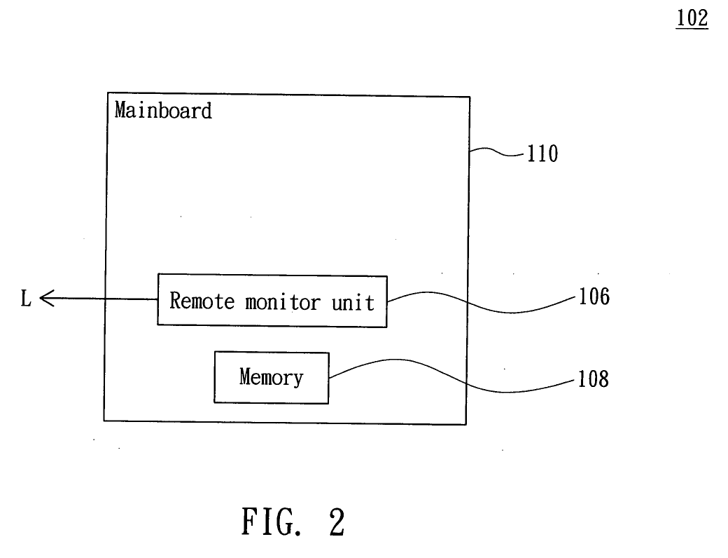

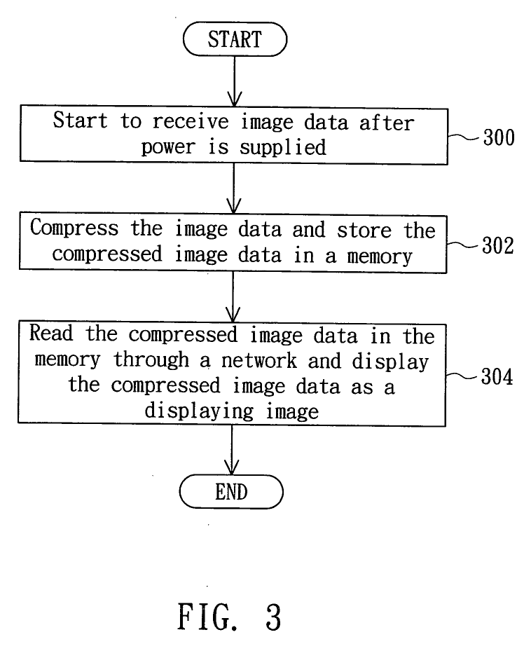

FIG. 2 is a schematic illustration showing the monitored computer system 102 according to a preferred embodiment of the invention. Referring to FIG. 2, the monitored computer system 102 has a mainboard 110, which includes a signal capturing unit 106 and a memory 108. The signal capturing unit 106, such as a microprocessor chip, is disposed on the mainboard 110, for example, and has the independent network interconnection function. Furthermore, as long as the supplied power exists, the signal capturing unit 106 can execute the associated operations without entering the operation system (e.g., Window operation system) of the monitored computer system 102. The memory 108 electrically connected to the signal capturing unit 106 stores the program for operating the signal capturing unit 106 and provides the memory space for computation. FIG. 3 is a flow chart showing a remote monitoring method according to the preferred embodiment of the invention. First, after the power is supplied to the monitored computer system 102, the signal capturing unit 106 starts to capture the image data (step 300). Then, the signal capturing unit 106 compresses the image data into compressed image data, and stores the compressed image data into the memory 108 (step 302). Finally, the monitoring computer system 104 reads the compressed image data through the network L and displays the compressed image data as an image frame (step 304).

In detail, the image data may be the image data of the monitored computer system 102 or the image data coming from the outside. When the image source is the image data of the monitored computer system 102, the signal capturing unit 106 captures the image data through the display unit (not shown) of the monitored computer system 102. For example, the signal capturing unit 106 and the display unit are integrated in the same chip to capture the image data of the monitored computer system 102. Thereafter, the signal capturing unit 106 compresses the captured image data into the compressed image data, stores the compressed image data into the memory 108, continuously updates the updated compressed image data stored in the memory 108 with the updating of the frame so as to keep the newest displaying image in the memory 108. On the other hand, because the signal capturing unit 106 itself has the network connection function, the monitoring computer system 104 can be connected to the signal capturing unit 106 through the network and read the compressed image data in the memory 108. Thereafter, the monitoring computer system 104 can display the displaying image which is currently outputted from the monitored computer system 102 according to the compressed image data. For instance, the monitoring computer system 104 can display the displaying image outputted from the monitored computer system 102 such that the user can see the displaying image through the network browser.

Consequently, the user can see the displaying image outputted from the monitored computer system 102 through the network browser on the monitoring computer system 104 immediately upon the booting of the monitored computer system 102, and the remote monitoring function is achieved. Most important of all, it is unnecessary to install the monitoring software in the monitored computer system 102 and the monitoring computer system 104, and the problem of incapable of monitoring the system due to the software crash of the monitored computer system will not be caused. Furthermore, the frame upon the crash of the monitored computer system 102 may also be stored such that the operator can judge the reason for causing the crash of the monitored computer system 102. The invention is not particularly limited to the type of the signal capturing unit 106, wherein the signal capturing unit 106 may be integrated with the display unit and also may be independently disposed on the mainboard 110 of the monitored computer system 102.

In addition, when the image source is the exterior image data (e.g., the image data coming from another computer system), the signal capturing unit 106 receives the image data through the corresponding connection interface. After the image data is received, the signal capturing unit 106 properly processes the exterior image data by way of, for example, image format conversion and image compression, and then stores the processed data into the memory 108. Similarly, the user can see the displaying image outputted from the monitored computer system 102 through the network browser on the monitoring computer system 104 immediately upon the booting of the monitored computer system 102.

As mentioned hereinabove, the invention provides a remote monitoring method of solving the prior art problem, in which the monitoring function cannot be achieved until the monitoring software enters the operation system, by disposing an independent microprocessor chip in the monitored computer system. Thus, the user can monitor the displaying frame using the typical network browser, and all the procedures from booting to normal operating or even the frame of crash can be monitored.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A remote monitoring method applied in a monitored computer system and a monitoring computer system which are connected to a network, the monitored computer system having a signal capturing unit and a memory, the method comprising the steps of:
enabling the signal capturing unit to start to capture image data after power is supplied to the monitored computer system;
enabling the signal capturing unit to compress the image data into compressed image data and store the compressed image data to the memory; and
enabling the monitoring computer system to read the compressed image data through the network and to display the compressed image data as an image frame.

2. The method according to claim 1, further comprising the step of:
converting an image format of the image data before the step of enabling the signal capturing unit to compress the image data into the compressed image data and store the compressed image data to the memory.

3. The method according to claim 1, wherein the monitoring computer system displays the image frame on a network browser.

4. The method according to claim 1, wherein the signal capturing unit captures the image data from a display unit of the monitored computer system when the image data is image data of the monitored computer system, and the signal capturing unit and the display unit are integrated together.

5. The method according to claim 1, wherein the signal capturing unit receives the image data, which is exterior image data coming from another computer system, through a connection interface.
